(19) United States
(12) Patent Application Publication
(10) Pub. No.: US 2014/0279357 A1
(43) Pub. Date: Sep. 18, 2014

(54) Methods, Systems, and Devices for Managing Financial Toxicity

(71) Applicant: CROSSRATE TECHNOLOGIES LLC, Sands Point, NY (US)

(72) Inventors: Peter G. Hirsch, Sands Point, NY (US); Kenneth Tremain, Mamaroneck, NY (US); David Light, New York, NY (US)

(73) Assignee: CROSSRATE TECHNOLOGIES LLC, Sands Point, NY (US)

(21) Appl. No.: 14/197,616

(22) Filed: Mar. 5, 2014

Related U.S. Application Data
(60) Provisional application No. 61/780,044, filed on Mar. 13, 2013.

(51) Int. Cl. G06Q 40/04

(52) U.S. Cl. CPC G06Q 40/04
USPC 705/37

(57) ABSTRACT

A system that analyzes toxic flow, retains the toxic flow with a dealer, and rebates all or a partial percentage of the toxic flow to liquidity providers in the market, The system allows clients and dealers can be identified by a number or code, and temporarily retains toxicity with the dealers until a predetermined amount of time and/or number of trades elapses. The dealers can then rebate back to the system any net toxicity beyond a random distribution, and the system can distribute any net toxicity beyond the random distribution to the liquidity providers. Buyers and sellers therefore receive a better price, and liquidity providers can operate with the comfort of knowing that their transactions will involve no toxicity above a random distribution.

### CROSS-REFERENCE TO RELATED APPLICATIONS

The present application claims priority to provisional application no. 61/780,044, filed Mar. 13, 2013, the contents of which are hereby incorporated by reference in their entirety.

### TECHNICAL FIELD OF THE INVENTION

The present application relates to managing financial transactions. Particularly, the present application relates to analyzing financial transactions and distributing revenue in accordance with the analysis.

### BACKGROUND OF THE INVENTION

Financial transactions are rarely conducted between two equally-footed parties. One party typically enjoys an informational edge by having personal knowledge of the transaction that is unknown to the buying party. Public exchanges (e.g., brokerage screens or futures pits) offer transparent pricing to all takers. Price takers who transact at an exchange understand that they will likely obtain a good (transparent) price, and will not have to give up information relating to the client they are representing in the transaction.

Market makers understand that with every purchase or sale, a transaction might result in a net loss, or otherwise be less lucrative, because the buyer or seller may have information unknown to the market maker. This information asymmetry causes the specific transaction to have a reasonable probability of being an immediate winner for the buyer or seller, above the normal occurrence for such an event. This will be referred to herein as “toxic flow” or “toxicity.”

A single transaction conveys no reliable statistical data relating to the future direction of the market or of the two parties involved in the transaction. A seller can have much more to sell, can have a unique information advantage, or can be “price direction random.” If a seller or buyer is “price direction random,” they are likely getting less than the best price possible because they are typically transacting at a price that, because it assumes some probability of toxicity, is worse than it could be if there was a guarantee of “price direction random” flow. Exchanges and broker screens do not identify a particular seller or buyer by name, and market participants have no way to gauge whether or not a particular seller or buyer has a higher or lower probability of being toxic, making the ex-ante identification of “price direction random selling or buying” especially problematic.

Generally, transacting dealers own the toxic flow of their clients. The dealers therefore attempt to avoid the cost of toxic flow through a proper due diligence process, on-boarding clients only when such clients offer them a reasonable probability of a return on a transaction, and not on-boarding clients who can cost them revenue over time. However, if market makers in public markets (e.g., brokerage screens or futures pits) could be assured of the less or non-toxic nature of certain client-driven flows, without knowing the names of the individual clients, the clients would achieve better execution and tighter bid/offered spreads.

### SUMMARY OF THE INVENTION

The present application discloses a system that analyzes toxic flow, retains the toxic flow with a dealer (price taker), and rebates a percentage of the toxic flow to price providers in the market. In some embodiments, the system requires each dealer to identify the dealer and/or their client by one or more numbers or codes. Dealers can retain the toxicity of their clients and, on a periodic basis, the total toxicity for all clients from a particular dealer is scored relative to a random distribution. The transacting dealers then rebate back to the system any net toxicity for the universe of clients beyond a random distribution, and the system distributes the net toxicity to the price providers.

The toxicity is therefore temporarily retained by the dealer and the price providers are rebated back most or all of the toxicity. Accordingly, price providers can bid and offer, without knowing the name of the buyer or seller, with the comfort of knowing that the flow will not be toxic beyond a random distribution. The buyer or seller also obtains a better price than they could achieve from the individual dealer without providing their actual name to the price providers.

In particular, the present application discloses a method for distributing revenue including receiving, at a server, a request for a quote (RFQ) on a security from a client among a plurality of clients in a group, setting a RFQ reference value for the security, receiving, at a server, a client decision to execute a transaction to purchase or sell the security, executing the transaction, determining a best price for the security at a time when the transaction is executed, determining an amount of toxicity by calculating a volume-weighted average price (VWAP) for securities transacted by each of the clients in the group over a predetermined period of time, calculating a random VWAP distribution for the securities, and determining additional revenue realized by the group of clients over the random VWAP distribution, rebating the additional revenue to a server, and distributing the additional revenue to a predetermined group of dealers and/or to at least one price provider of the securities.

The present application also discloses a method of distributing revenue including receiving, by a dealer, a proposed trade on a security from a client among a plurality of clients in a group, receiving, at a server, the proposed trade from the dealer, setting a trade reference price for the security, receiving, at a server, a decision to execute the proposed trade, executing the proposed trade to establish a transaction, determining a best price for the security at a time when the transaction is executed, determining an amount of toxicity by calculating a volume-weighted average price (VWAP) for securities transacted by each of the clients in the group over a predetermined period of time, calculating a random VWAP distribution for the securities, and determining additional revenue realized by the group of clients over the random VWAP distribution, rebating the additional revenue to a server, and distributing the additional revenue to a predetermined group of dealers.

The present application also discloses a method for distributing revenue including providing a visible screen where a bid and/or offer relating to a security can be obtained by a dealer among a plurality of dealers in a dealer group, wherein the security is offered by a liquidity provider among a plurality of liquidity providers in a liquidity provider group, receiving, at a server, a dealer decision to execute a transaction to purchase or sell the security, executing the transaction with the liquidity provider, determining an amount of toxicity by calculating a volume-weighted average price (VWAP) for securities transacted by each of the dealers in the group over a predetermined period of time, calculating a random VWAP distribution for the securities, and determining additional revenue realized by the group of dealers over the random VWAP distribution, rebating the additional revenue to a server, and distributing the additional revenue to at least one liquidity providers.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of a network according to embodiment(s) of the present application.

FIG. 2 is a schematic diagram of a user device according to embodiment(s) of the present application.

FIG. 3 is a flowchart illustrating a method according to embodiment(s) of the present application.

FIG. 4 is a flowchart illustrating a method according to embodiment(s) of the present application.

FIG. 5 is a schematic diagram of an embodiment of the present application where more direct security transfers occur.

FIG. 6 is a flowchart of an embodiment of the present application here more direct security transfers occur.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a system that analyzes toxic flow, retains the toxic flow with a dealer, and rebates all or a partial percentage of the toxic flow to price providers in the market. Clients and dealers can be identified by only a number or code, and dealers can temporarily retain the toxicity of their clients until a predetermined amount of time and/or number of trades elapses. At that time, or at any other periodic or random basis, the dealers then rebate back to the system any net toxicity beyond a random distribution, and the system distributes any net toxicity beyond a random distribution to the price providers. Buyers and sellers therefore receive a better price, and price providers can operate with the comfort of knowing that their transactions will involve no toxicity above a random distribution.

As shown in FIGS. 1 and 2, the systems described in the present application can be implemented as a system, a method, and/or as a computer program embedded within one or more computer-readable recording media and/or a user device, for example. FIG. 1, for example, discloses a system 100 according to the present application, including a price provider 105, dealer 110, and client 115. For the purposes of discussion, the client 115 will be assumed to be the end buyer or seller that bids on a security sold or bought by the price provider 105.

The price provider 105, dealer 110, and client 115 can interact over one or more networks 120, whereby the parties 105, 110, 115 can be directly or indirectly communicably coupled together by one or more communication links 125. Further, the parties 105, 110, 115 can individually, collectively, or separately include one or more user devices 130 upon which certain steps of the system 100, or all steps of the system 100, can be implemented within one or more software programs stored on one or more computer-readable medium. The system 100 can also be implemented as a software program on a server 135 communicably coupled to the parties 105, 110, 115.

The network 120 may be a single network or a plurality of networks of the same or different type. For example, the network 120 may include a local telephone network (such as a Bell Atlantic telephone number) in connection with a long distance network (such as an AT&T long distance telephone network). Further, the network 120 may be a data network, an Intranet, the Internet or a telecommunications network in connection with a data network. Any combination of telecommunications and data networks may be used without departing from the spirit and scope of the present application. For purposes of discussion, it will be assumed that the network 120 is the Internet.

The communication links 125 may be any type of connection that allows for the transmission of information. Some examples include conventional telephone lines, fiber optic lines, direct serial connections, cellular telephone connections, satellite communication links, local area networks (LANs), intranets, and the like.

The user device 130 can be a device of any type that allows for the transmission and/or reception of data. By way of example, the user device 130 can include a smart phone (e.g. iPhone), personal computer, voice and video telephone set, streaming audio and video media player, integrated intelligent digital television receiver, work station, radio, personal digital assistant (PDA), mobile satellite receiver, GPS receiver, software system, social network or any combination of the above.

The server 135 can also be a device of any type that allows for the transmission and/or reception of data, and that is capable of storing information to be transmitted to the user device 130. For example, the server 135 can include any device listed above with respect to the user device 130, or can include any non-transitory computer-readable recording medium, such as a hard drive, DVD, CD, flash drive, volatile or non-volatile memory, RAM, or any other type of data storage.

FIG. 2 illustrates a schematic diagram of the user device 130 according to an embodiment of the present application. As shown, the user device 130 includes an interface 205, a processor 210, a transceiver 215, a display 220, and a memory 225, each communicably coupled to one another by any known means.

The interface 205 allows the user to input information or commands into the user device 130 and to transmit the information or command to the server 135 via the network 120. By way of example, the interface 205 can include a keyboard, mouse, touch screen, audio recorder, audio transmitter, member pad, or any other device that allows for the entry of information from a user.

The processor 210 facilitates communication between the various components of the user device 130. The processor 210 can be any type of processor or processors that alone or in combination facilitate communication within the user device 130 and, together with the transceiver 215, are adapted to transmit information from the user device 130 to external devices. For example, the processor 210 can be a desktop or mobile processor, a microprocessor, a single-core or a multi-core processor.

The transceiver 215 can be any device capable of transmitting data from the user device 130 or capable of receiving data within the user device 130 from an external data source. By way of example, the transceiver 215 can be any type of radio transmission antenna, cellular antenna, hardwired transceiver, or any other type of wired or wireless transceiver capable of communicating with an external device.

In an embodiment, the display 220 can display various information for the user to view and interpret information, search engines, text or graphics, or information entered into the interface 205. By way of example, the display 220 can include a liquid crystal display (LCD), organic light emitting diode (OLED) display, plasma screen, cathode ray tube display, or any other kind of black and white or color display that will allow the user to view and interpret information on the user device 130.

In an embodiment, the memory 225 can store any information from the server 115 via the network 120 or any information not received through the server 135 or network 120. The memory 225 can also store an operating system for the user device 130 or any other software or data that may be necessary for the user device 130 to function. Similar to the server 135 discussed above, the memory 225 can include any non-transitory computer-readable recording medium, such as a hard drive, DVD, CD, flash drive, volatile or non-volatile memory, RAM, or any other type of data storage.

FIG. 3 illustrates one method 300 according to the present application. As shown, the process 300 begins and proceeds to step 305, where a client 115 sends a request for a quote (RFQ) on a particular security. The request can be sent by the client 115 to the system 100 via the server 135, or can be sent directly to the price provider 105 or dealer 110.

After the request is sent, the RFQ reference level is then set in step 310. For example, if a client 115 wishes to sell $100 million of a 10-year US treasury bond, the system 100 can set the reference price to $100 million plus $45 per million par. This reference level is typically achieved by the system 100 analyzing existing data or requesting the bid from the dealer 110 and/or price provider 105. However, the RFQ reference level can be determined by any component of the system 100 or in any way, without departing from the spirit and scope of the present application.

Once provided with the appropriate reference level, the client 115 then decides whether to execute the transaction in step 315. Of course, if the client 115 decides not to execute the transaction, the process 300 ends and awaits the next RFQ. Otherwise, the process 300 proceeds to step 320, where the system 100 determines the best streaming price of the security at the time of execution. Here, the system 100 re-analyzes appropriate data o RFQ responses and optionally communicates that data to the client 115 before executing the trade at the best streaming price in step 325. In the example discussed above, the best streaming rate is now $100 million plus $52 per million par, or $7 per million par better than the previous response to RFQ, and the transaction is executed at that price.

Following execution of the trade 330, the process 300 proceeds to step 330 where revenue distributions are calculated and distributed. In the example discussed above, the dealer 110 would be informed that a timing adjustment occurred and that $700 was realized from the difference of execution price and RFQ reference price. The system 100 therefore produced a net routing profit of $4,500, which would include the RFQ reference price minus the execution rounded price, or $10 million plus $45 per million par minus $10 million. The dealer 110 would net a profit of $2,950, which would be 50% of the routing profit ($4,500*0.50=$2,250) and the full amount of the timing adjustment ($700). The system 100 would net the other 50% of the routing profit ($2,250). All revenue could be distributed electronically at the time of the transaction or at another time, and the above amounts and percentages are merely exemplary.

In an embodiment, within step 330, a statistical analysis is conducted to determine whether the client 115 or dealer 110 are consistently achieving better-than-average results, which may be indicative of information asymmetry. For example, the method 300 within step 330 can compute the volume-weighted average price (MAP) of each client 105 from a particular dealer 110 on a periodic basis. Alternatively, or in addition to the above, VWAP analysis can be conducted on all clients 115 of a particular dealer or group of dealers 110 and such VWAP analysis can be compared against a random VWAP distribution. Any additional revenue realized by the dealer 110 or dealers 110 beyond the random VWAP distribution can then be rebated back to the system 100 and distributed to the price providers 105. The price providers 105 can therefore transact easily and freely with clients 105 without worrying about the toxicity of the clients 115 or dealers 110. The clients 115 can also transact freely knowing they are getting the best possible price.

FIG. 4 discloses another embodiment of the present application. In this embodiment, the process 400 starts and proceeds to step 405, where the dealer 110 sends a proposed trade to the system 100, for example, to the server 135. The system 100 can then set the trade reference price, similar to the RFQ reference price process discussed above, and all relevant information (the trade reference price, identifying information of the dealer, if applicable, etc.) can then be sent to the client in step 415. The client can then determine whether to execute the trade 420, and if so, the system 100 determines the streaming price at the time of execution 425 similar to the embodiment in FIG. 3. The trade is then executed in step 430, and revenue is distributed in step 435. Afterwards, the process 400 ends.

The above process is effective for the vast majority of trades. For smaller trades (for example, $1 million or less) executed relatively quickly on the same security (for example, fifty trades in five seconds), little toxicity will be shown. However, the liquidity provider will be paid disproportionately relative to what they would have received if the trade had been bundled. The system can therefore use a matrix of size and time increments that can be “re-bundled” in a mathematical sense, after a certain amount of time or after a certain number of trades are executed. The transacting parties can thereafter receive a new price that properly reflects the true volume and where the liquidity provider receives back compensation equal to what the true bid or offer would have been for the entirety of the “size” of the transaction. Additionally, for especially large transactions that have some reasonable probability of discontinuous price action, the system can calculate the VWAP at a multiple of 100% of the trade size.

FIGS. 5 and 6 illustrate an embodiment of the present application where more direct security transfers occur. As shown, the system 500 is similar to the system 100 in FIG. 1. The system 500 includes a price provider 505, dealer 510, client 515, and server 535, where the server 535 includes software operable to facilitate the system 500. The individual price providers are represented as 505a-505n, the dealers as 510a-510n, and the end clients as 515a-515n. The system 500 of FIGS. 5 and 6 illustrate a more direct process where the dealer 510 (or liquidity consumer) purchases directly from the system 500, viewing the system 500 as a liquidity pool.

The software on the server 535 or otherwise incorporated into the system 500 includes a visible screen 536 and a liquidity venue 537. The visible screen 536 works like conventional securities brokers in that it provides the base of pricing to use in the liquidity venue 537. The system 500 can guarantee to the dealer 510 that the liquidity venue 537 will never have a worse price, and will often have a better price, relative to the dealer 510, than the visible screen 536. For example, the visible screen 536 can reference a bid of 100 and an offer of 101 for a $100 million security. In this example, the liquidity consuming dealer 510 can sell the $100 million security and is guaranteed a price of 100. However, the dealer 510 is likely to achieve a greater price because the toxicity of the system 500 will be rebated to the price providers 505, as discussed above with respect to FIGS. 3 and 4, ensuring a “clean” transaction and better prices.

An example of this process is shown in FIG. 6. As shown, the process 600 begins and proceeds to step S605, where a dealer 510 views the visible screen 536 of the system 500. Here, for example, the dealer 510 can be assured by the system 500 of a bid of 100 and an offer of 101 on a particular security. The dealer 510 can then determine whether to execute the transaction in step 610. If the dealer 510 declines to execute the transaction, the process 600 reverts to step S605. However, if the dealer 510 decides to execute the transaction, the process 600 proceeds to step S615 and the system 500 executes the transaction with the liquidity provider 505.

Toxicity is then determined in step S620. For example, a statistical analysis is conducted to determine whether the dealer 110 is consistently achieving better-than-average results, which may be indicative of toxicity. Step S620 can therefore compute the volume-weighted average price (VWAP) of each dealer 510 on a periodic basis and compare it against a random VWAP distribution. Any additional revenue realized by a particular dealer 510 or dealers 510 beyond the random VWAP distribution can then be rebated back to the system 500 and distributed to the price providers 505 in step S625. Following step S625, the process 600 ends.

Distribution of revenue in the above embodiments can be conducted electronically, for example, by transmitting electronic data from the server 135 to user devices 130 or electronic memories of the various entities 105, 110, 115 or financial institutions thereof. The user devices 130 of the entities 105, 110, 115 or financial institutions thereof are typically, although not always, located outside of the confines of the server 135. All calculations conducted above could also be done electronically.

As used herein, the term “coupled” or “communicably coupled” can mean any physical, electrical, magnetic, or other connection, either direct or indirect, between two parties. The term “coupled” is not limited to a fixed direct coupling between two parties or by any other limitation.

Some embodiments of the present application are discussed herein as being embodied within the method(s) 300, 400. However, the method(s) 300, 400 themselves, or any other method or individual step discussed herein, can be embodied on one or more of the user device 130 of any of the parties 105, 110, 115, the server 135, or network 120, without departing from the spirit and scope of the present invention. Further, the methods discussed herein, or any individual steps thereof, can be embodied on non-transitory a computer-readable medium of the user device 130 (described above as the memory 225), server 135, or any other non-transitory computer-readable medium on the network 120 and communicable with the user device 130 and/or the server 135. In each case, the non-transitory computer-readable recording medium can be any device capable of storing data, including but not limited to a hard drive, DVD, CD, flash drive, volatile or non-volatile memory, RAM, or any other type of data storage.

The processes described above are illustrative only and provide one possible method of implementing the invention. The processes are not meant to be limited to the order in which the steps are written, nor are any of the steps intended to be considered mandatory to carry out the inventive process. Any of the steps can be considered optional and the steps of any method disclosed herein can be performed in any order without departing from the spirit and scope of the present invention.

The phrase “predetermined period of time,” as used herein, can refer to a predetermined amount of temporal time, or can refer to a predetermined number of transactions that are conducted.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for distributing revenue comprising:
receiving, at a server, a request for a quote (RFQ) on a security from a client among a plurality of clients in a group;
setting a RFQ reference value for the security;
receiving, at a server, a client decision to execute a transaction to purchase or sell the security;
executing the transaction;
determining a best price for the security at a time when the transaction is executed;
determining an amount of toxicity by:
calculating a volume-weighted average price (VWAP) for securities transacted by each of the clients in the group over a predetermined period of time;
calculating a random VWAP distribution for the securities; and
determining additional revenue realized by the group of clients over the random VWAP distribution;
rebating the additional revenue to a server; and
distributing the additional revenue to a predetermined group of dealers and/or to at least one price provider of the securities.

2. The method of claim 1, wherein the group of clients are clients associated with a dealer.

3. The method of claim 1, further comprising determining the RFQ reference value by one of a bid request and an analysis of data regarding a price of the security.

4. The method of claim 1, further comprising determining a routing profit of the transaction and distributing the routing profit to the dealer.

5. A method of distributing revenue comprising:
receiving, by a dealer, a proposed trade on a security from a client among a plurality of clients in a group;
receiving, at a server, the proposed trade from the dealer;
setting a trade reference price for the security;
receiving, at a server, a decision to execute the proposed trade;
executing the proposed trade to establish a transaction;
determining a best price for the security at a time when the transaction is executed;
determining an amount of toxicity by:
calculating a volume-weighted average price (VWAP) for securities transacted by each of the clients in the group over a predetermined period of time;
calculating a random VWAP distribution for the securities; and
determining additional revenue realized by the group of clients over the random VWAP distribution;
rebating the additional revenue to a server; and
distributing the additional revenue to a predetermined group of dealers.

6. The method of claim 5, further comprising transmitting financial information to the client prior to executing the transaction.

7. The method of claim 5, wherein the group of clients are clients associated with a dealer.

8. The method of claim 5, further comprising determining the trade reference price by one of a bid request and an analysis of data regarding a price of the security.

9. The method of claim 5, further comprising determining a routing profit of the transaction to the dealer and distributing the routing profit to the dealer.

10. A method for distributing revenue comprising:
providing a visible screen where a bid and/or offer relating to a security can be obtained by a dealer among a plurality of dealers in a dealer group, wherein the security is offered by a liquidity provider among a plurality of liquidity providers in a liquidity provider group;
receiving, at a server, a dealer decision to execute a transaction to purchase or sell the security;
executing the transaction with the liquidity provider;
determining an amount of toxicity by:
calculating a volume-weighted average price (VWAP) for securities transacted by each of the dealers in the group over a predetermined period of time;
calculating a random VWAP distribution for the securities; and
determining additional revenue realized by the group of dealers over the random VWAP distribution;
rebating the additional revenue to a server; and
distributing the additional revenue to at least one liquidity providers.

11. The method of claim 10, further comprising determining a RFQ reference value of the security by one of a bid request and an analysis of data regarding a price of the security.

12. The method of claim 10, further comprising determining a routing profit of the transaction and distributing the routing profit to the at least one liquidity providers.
